(19) United States
(12) Patent Application Publication
(10) Pub. No.: US 2026/0036962 A1
(43) Pub. Date: Feb. 5, 2026

(54) METHOD AND SYSTEM FOR GENERATING ASSEMBLY DRAWINGS FOR BUILDING CONSTRUCTION

(71) Applicant: Consulting Engineers, Corp., Reston, VA (US)

(72) Inventor: Maharaj Jalla, Great Falls, VA (US)

(21) Appl. No.: 18/792,010

(22) Filed: Aug. 1, 2024

Related U.S. Application Data
(63) Continuation of application No. 16/714,702, filed on Dec. 14, 2019, now abandoned.
(60) Provisional application No. 62/912,692, filed on Oct. 9, 2019.

(51) Int. Cl. G05B 19/408; G05B 19/4099

(52) U.S. Cl. CPC G05B 19/4083; G05B 19/4099

(57) ABSTRACT

A computer method for generating a set of assembly illustrations, comprising: accessing, a building frame, wherein the building frame is comprised of a set of sections; analyzing, the set of sections, wherein a section type is determined for each section; identifying, each member of each section of the set of sections; analyzing, an interface between each member of each section to determine if any conflicts between members is present, wherein if a conflict is identified modifying at least one of the members to correct the conflict; processing, an assembly process of each section and determining if any conflicts between members is present; generating, a set of illustrations depicting the members of the section in an assembled and disassembled position; and generating, a set of data associated with each of the members, wherein the set of data is readable by the cold rolling machine to produce each of the members.

### CROSS-REFERENCE TO RELATED APPLICATIONS

This application is a continuation-in-part (and claims the benefit of priority under 35 USC 120) of U.S. provisional application No. 62/912,692 filed Oct. 9, 2019, and U.S. Utility application Ser. No. 16/714,702 filed on Dec. 14, 2019. The disclosure of the prior applications is considered part of (and is incorporated by reference in) the disclosure of this application.

### BACKGROUND

This disclosure relates generally to building construction and in particular, to a method, computer program, or computer system for analyzing a building to generate assembly drawings for the walls, roofs, and floors and other structural features of the building.

Building construction is a complicated process in which the step of assembly of the framing members to form an assembly or panel or frame is time consuming activity. In pre-engineering building construction, where the members for building framing are pre-engineered and premanufactured, the assembly of the members together to form the panel or frame is critical.

The traditional method of assembly of the buildings in which the member placement, fasteners requirement has to be corelated from some other drawings is time consuming and the chances of error are more. There is a lot of wastage of the material on site due the Incorrect information.

During the building construction, the majority of the time is consumed for the assembly of the frame. The workers in the factory assembling the frame are typically not skilled laborers. For an unskilled worker to read and assemble the members together can be a time-consuming activity and delay the overall construction process. Typically, these workers need to either have the entire process meticulously explained to them, or they have to be walked through the process for each section of the frame.

It is desired to have a system or method to generate drawings for the building frame, that permits even unskilled laborers to easily and quickly put the frame together with little to no errors. The creation of a set of drawings that are specific to the building, clearing identify each section, each frame member, and the order to install each member would provide a substantial advantage over the current methods which are used to generate drawings for the assembly of buildings and structures.

### SUMMARY

In the first embodiment, the present invention is a computer a method for generating an assembly illustration set for the construction of a building via a computing device, comprising: accessing, by one or more processors, a model of a structure, wherein the model of the structure is comprised of a series of sections, and the series of structures are formed of members; isolating, by one or more processors, a section from the structure; detecting, by one or more processors, the section, wherein a section type is identified; identifying, by one or more processors, each member of the section, and each feature of each member; determining, by one or more processors, if conflicts are present between any members of the section, and wherein if a conflict between any members is determined identifying an amendment to at least one member and resolve the determined conflict; applying, by one or more processors, the amendment to at least one member, and wherein the amendment resolves the conflict; creating, by one or more processors, an assembly process of the section; and generating, by one or more processors, a set of illustrations depicting the section and the members; and generating, by one or more processors, data for manufacturing machinery, wherein the data includes an assembly process of each member and of the section.

In the second embodiment for the present invention is computer program product for generating assembly plans, comprising, the computer program product comprising a computer-readable storage medium having program instructions embodied therewith, the program instructions executable by a computing device to cause the computing device to: program instructions to access a set of sections of a frame, wherein the sections are comprised of a set of members; program instructions to analyze the set of sections, wherein it is determined the type of section each section represents; program instructions to identify each member of the set of members that comprise each of the sections of the set of sections; program instructions to analyze the members and determine if the members have a conflict within the section, wherein if it is determined that a conflict exists to identify the conflict; and program instructions to generate a set of illustrations depicting the members of the section in an assembled and disassembled position.

In the third embodiment, the present invention is a system comprising: a CPU, a computer readable memory, and a computer readable storage medium associated with a computing device; program instructions to access a model, wherein the model is comprised of a set of sections and each section is comprised of a set of members; program instructions to analyze the set of sections to determine the type of each section, wherein an assembly process is associated with each type of section; program instructions to identify each individual member of the set of members that comprise each of the sections of the set of sections; program instructions to analyze the set of members and the assembly process and determine if any members have a conflict; program instructions to identify the members who are involved in the conflict based on the assembly process; program instructions to modify the members involved in the conflict to overcome the conflict; and program instructions to generate a set of illustrations depicting the set of members of each of the sections, wherein the set of illustrations identifies the assembly order and process.

### BRIEF DESCRIPTION OF THE DRAWINGS

FIG. 1 depicts a block diagram depicting a computing environment, in accordance with one embodiment of the present invention.

FIG. 2 depicts a block diagram depicting the internal and external components of the server and computing device of FIG. 1, in accordance with one embodiment of the present.

FIG. 3 depicts a cloud computing environment, in accordance with one embodiment of the present invention.

FIG. 4 depicts a flowchart of the operational steps of generating a set of drawings for the assembly of a section of a frame within the computing environment of FIG. 1, in accordance with one embodiment of the present invention.

FIG. 5 depicts a flowchart of the operational steps of generating a set of drawings for the assembly of a section of a frame within the computing environment of FIG. 1, in accordance with another embodiment of the present invention.

FIG. 6 depicts an illustration of a user interface depicting a member, in accordance with one embodiment of the present invention.

FIG. 7 depicts an illustration of a user interface depicting a member, in accordance with one embodiment of the present invention.

FIG. 8 depicts an illustration of a user interface depicting a member, in accordance with one embodiment of the present invention.

FIG. 9 depicts an illustration of a user interface depicting an assembly, in accordance with one embodiment of the present invention.

FIG. 10 depicts an illustration of a wall section, in accordance with one embodiment of the present invention.

FIG. 11 depicts an illustration of a disassembled wall section, in accordance with one embodiment of the present invention.

FIG. 12 depicts an illustration of a floor joist in an assembled view and a disassembled view, in accordance with one embodiment of the present invention.

FIG. 13 depicts an illustration of a roof truss in an assembled view and a disassembled view, in accordance with one embodiment of the present invention.

FIG. 14 depicts an illustration of a user interface depicting a disassembled wall section, in accordance with one embodiment of the present invention.

FIG. 15 depicts an illustration of a user interface depicting a disassembled floor joist, in accordance with one embodiment of the present invention.

FIG. 16 depicts an illustration of a user interface depicting a disassembled roof truss, in accordance with one embodiment of the present invention.

### DETAILED DESCRIPTION

The present invention generally relates to a method for analyzing a building, identifying different structural portions of the building, and determining an assembly process for these structural portions. The present invention then generates illustrations or drawings that depict the members and an assembly process for each section or portion. The drawings/illustrations provide all the necessary information a worker would need to construct each section. This includes each and every detail the worker would need, down to the number and type of screws needed, the specific placement of each member, and the order of assembly so that the worker can easily and correctly assemble each section.

The present invention provides the advantage by incorporating the analysis of a 3D model or a 2D drawing and determines all members that are needed to build the structure and a construction method as well. The correct placement of each member is important as this affects the assembly process and the integrity of the assembly. Additionally, in the assembly process, there are sometimes, upwards of thousands if not millions of members, and many of the members may visually appear identical, but may be designed for specific applications that may not be readily apparent to the worker. By placing the wrong member in the wrong position, could result in a deficiency in the building construction and lead to serious problems or injuries. Equally as important are the fasteners or securing methods that are used to secure the members (and in some instances the sections) together. Again, different connection points require different fasteners or securing means and the incorrect type of fastener or securing method could result in deficiencies in the structural integrity of the building.

For each section or portion, the correct no. of fasteners, special fastener requirements at any particular junction have to be shown so the over-estimation of material on site can be avoided and also any special fastener requirement as per engineering calculation at any particular junction is correctly provided in the generated drawings.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other devices to cause a series of operational steps to be performed on the computer, other programmable apparatus, or other devices to produce a computer-implemented process, such that the instructions which execute on the computer, other programmable apparatus, or other devices implement the functions/acts specified in the flowchart and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustrations, and combinations of blocks in the flowchart illustrations, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:
Software as a Service (Saas): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

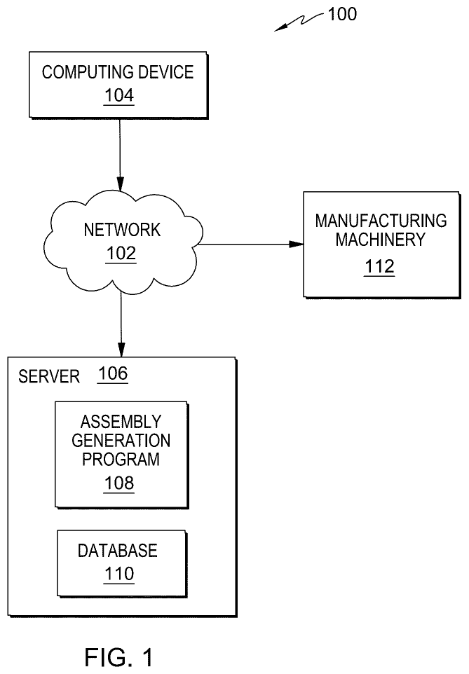

FIG. 1 depicts a block diagram of a computing environment 100 in accordance with one embodiment of the present invention. FIG. 1 provides an illustration of one embodiment and does not imply any limitations regarding the environment in which different embodiments may be implemented.

In the depicted embodiment, computing environment 100 includes network 102, computing device 104, and server 106. Computing Environment 100 may include additional servers, computers, or other devices not shown.

Network 102 may be a local area network (LAN), a wide area network (WAN) such as the Internet, any combination thereof, or any combination of connections and protocols that can support communications between computing device 104 and server 106 in accordance with embodiments of the invention. Network 102 may include wired, wireless, or fiber optic connections.

Computing device 104 may be a management server, a web server, or any other electronic device or computing system capable of processing program instructions and receiving and sending data. In other embodiments, computing device 104 may be a laptop computer, tablet computer, netbook computer, personal computer (PC), desktop computer, or any programmable electronic device capable of communicating with patient computing device 104 via network 102. In other embodiments, computing device 104 may be a server computing system utilizing multiple computers as a server system, such as in a cloud computing environment. In one embodiment, computing device 104 represents a computing system utilizing clustered computers and components to act as a single pool of seamless resources. Computing device 104 may include components, as depicted and described in further detail with respect to FIG. 1.

Server 106 may be a management server, a web server, or any other electronic device or computing system capable of processing program instructions and receiving and sending data. In other embodiments server 106 may be a laptop computer, tablet computer, netbook computer, personal computer (PC), a desktop computer, or any programmable electronic device capable of communicating via network 102. In one embodiment, server 106 may be a server computing system utilizing multiple computers as a server system, such as in a cloud computing environment. In one embodiment, server 106 represents a computing system utilizing clustered computers and components to act as a single pool of seamless resources. In the depicted embodiment conflict identification program 108 and database 110 are located on server 106. Server 106 may include components, as depicted and described in further detail with respect to FIG. 1.

Assembly generation program 108 has the unique feature of being able to analyze a building model (or drawings) to determine an assembly process for each section of the building, and through this analysis, create illustrations of the sections (e.g. wall panels, roof trusses, floor trusses, and the like) and the members which these sections are comprised of to allow for workers to perform their jobs more efficiently or to allow various types of machines (e.g. cold form rolling machines, CNC machines, etc.) to manufacture the hundreds of thousands of members with minimum work. Illustrations are used to describe the drawings, but also could be used to describe the computer files that contain this information. For instance, where the illustration of a member is provided to a cold form rolling machine, the data within the illustration is provided to the machine's computer. Through the process of creating the illustrations of the sections and/or members, the assembly generation program 108 also has the unique feature of being able to analyze the section(s) to determine if there are any conflicts between members or sections. A conflict is where two or more parts of the building model are overlapping or interfacing in a way that would not be possible in the real world. This can be a common occurrence in 3D modeling where the model files are not properly mated to one another, or where a shift in one model has an effect on another member. This is important, as conflicts in the models may result in the final dimensions and design of the members to be incorrect.

In the depicted embodiment, assembly generation program 108 utilizes network 102 to access the computing device 104 and to communicate with database 110. In one embodiment, assembly generation program 108 resides on computing device 104. In other embodiments, assembly generation program 108 may be located on another server or computing device, provided assembly generation program 108 has access to database 110.

Database 110 may be a repository that may be written to and/or read by assembly generation program 108. Information gathered from computing device 104 and the 1-dimensional, 2-dimensional, and 3-dimensional drawings and models as well as the requirements so that the assembly drawing in one embodiment, database 110 is a database management system (DBMS) used to allow the definition, creation, querying, update, and administration of a database(s). In the depicted embodiment, database 110 resides on computing device 104. In other embodiments, database 110 resides on another server, or another computing device, provided that database 110 is accessible to Conflict identification program 108.

Manufacturing Machinery 112 refers to any machinery that would be used in the manufacturing process of the members and/or the assemblies. This can include a forming machine or a roll-forming machine that is able to create the members. The machinery may also be used to create the features on/in each of the members for the cutouts, apertures/openings, or the like. Multiple different pieces of machinery may be used to work with the assembly generation program to create each member with each specific feature. In the depicted embodiment, manufacturing machinery 112 is connected to network 102 to communicate with the computing device 104 and the server 106.

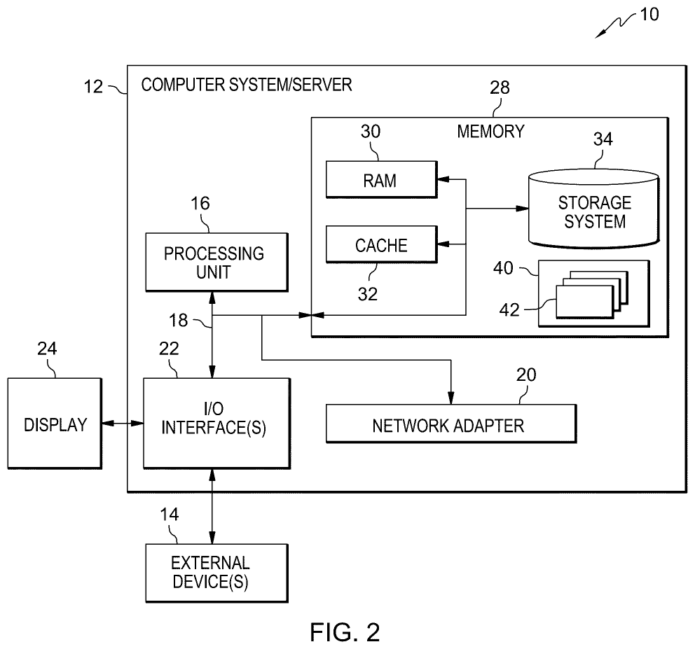

FIG. 2, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purposes or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

FIG. 2, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of the computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

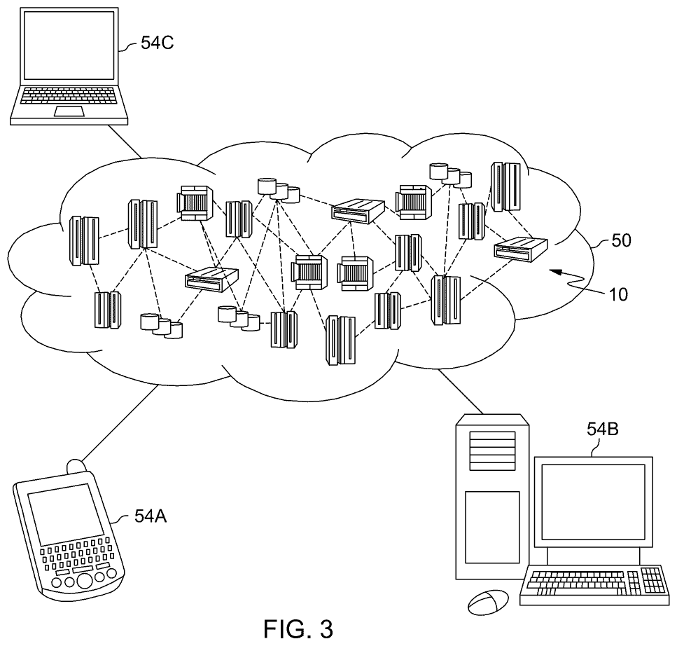

FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or additional computer systems may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-C shown in FIG. 2 are intended to be illustrative only and that computing nodes 10 and cloud computing environment 50 can communicate with any type of computerized device over any type of network and/or network addressable connection (e.g., using a web browser).

Referring back to FIG. 2, the Program/utility 40 may include one or more program modules 42 that generally carry out the functions and/or methodologies of embodiments of the invention as described herein. Specifically, the program module 42 may analyze a model of a building and create a set of illustrations for each wall, floor truss, and roof truss section. These illustrations depict the assembly process, the specific location and position of each member, and in some instances the position of the fastener and the type of fastener to use. The program is also able to identify if two or more members have conflicts and identify a potential solution to this conflict, so that the assembly process of the section(s) can be without issues. The unique feature of analyzing a model or drawing, determining the ideal construction/assembly method for the model, section, or sub-section, and creating a set of drawings or illustrations to assemble the part of the building. Other functionalities of the program module 42 are described further herein such that the program modules 42 are not limited to the functions described above. Moreover, it is noted that some of the modules 42 can be implemented within the infrastructure shown in FIGS. 1-3.

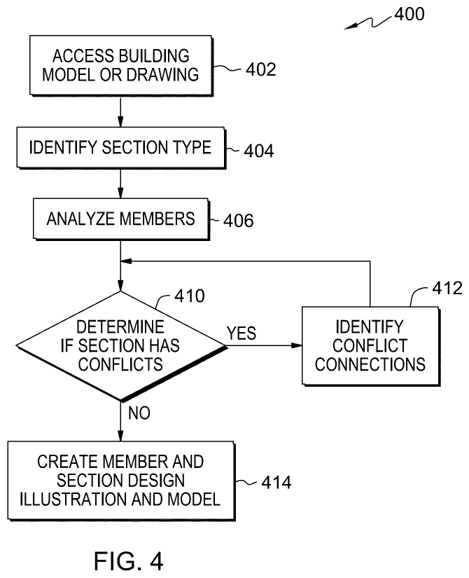

FIG. 4 depicts a flow chart 400 depicting a method according to the present invention. The method(s) and associated process(es) are now discussed, over the course of the following paragraphs, in accordance with one embodiment of the present invention. The program(s) described herein are identified based on the application for which they are implemented in a specific embodiment of the invention. However, it should be appreciated that any particular program nomenclature herein is used merely for convenience, and thus the invention should not be limited to use solely in any specific application identified and/or implied by such nomenclature.

In step 402, the assembly generation program 108 accesses the building model or the drawings. The building frame is identified, and the distinct sections are identified. Each section is comprised of members which are further identified. In some embodiments, the sections are created by the assembly generation program 108 based on the building model design and known section designs which can be extracted from the building model. The building or sections may be 3D models or 2D drawings. The model or drawings may have each member pre-identified. In other embodiments, the model or drawings do not identify each individual member identified or created, and the assembly generation program 108 is able to create estimates for the members.

In step 404, the assembly generation program 108 identifies a section type for each section of the frame or building model. Each section that is present in the building is able to be identified to a specific type of section based on the design and layout of the section. This may be, but not limited to, walls, roof trusses, floor trusses, or other section types based on the type of building. Each section type has a different set of features, characteristics, and general properties that the assembly generation program 108 uses when applying modifications and identifying issues (e.g. conflicts or strength requirements) within the model.

In step 406, the assembly generation program 108 analyzes each member of each of the sections. Through the analysis of each member, the assembly generation program 108 is able to determine the various physical features of each member, the interface and connection types of each member, and various other properties of the members to perform the necessary conflict checks, strength analysis, determine if any modifications need to be made to the members, and also identify a manufacturing process of the member. The interface/connection types are the areas where one member connects or comes in contact with another member. This can be about a fastening location (e.g. 907), or a feature such as dimple or a flange cut. In some instances where members are cold rolled steel, a machine is able to produce certain members based on the model files which are created by the assembly generation program 108. These files/data can be sent to a machine that is able to produce the physical model. Where the section(s) is/are constructed of individual members, the assembly generation program 108 is able to extract the member model and the data associated with the member model. In embodiments, where the sections are not constructed of individual members or incomplete members, the assembly generation program 108 is able to analyze the section and create a model of the member and generate associated data. This is used to determine the interface between the members. The assembly generation program 108 is able to identify features of the members which are associated with the assembly process and interface with other members, as well as features of the members which do are not part of the assembly process but merely features of the members.

In decision 410 the assembly generation program 108 determines if there are section-to-section conflicts, or member-to-member conflicts. A conflict arises where when two or more members or sections (or both) are not properly positioned within the 3D model or 2D drawing resulting in an overlap of the sections or members and would not be able to be assembled properly because of the members or sections not fitting together correctly. The conflict may also be issues with the alignment of fastening locations, joints, edges, and the like. The assembly of each section requires an analysis of the assembly process to determine the joints, fasteners, crimping, and attachment of each member to create the final section. If the assembly generation program 108 determines a conflict exists, the assembly generation program 108 identifies corrections to the conflict (step 412). If the assembly generation program 108 does not determine any conflicts are present, the assembly generation program 108 processes to generate the illustrations of the section and members (step 414).

In step 412 the assembly generation program 108 identifies at least one correction or solution to the conflicts based on an analysis of the members or sections involved in the conflict. These corrections or solutions are determined based on the construction requirements and may provide more than one correction type or solution. The corrections may include moving members, modifying members, or the replacement of members to adhere to the construction requirements. In some embodiments, a third party needs to confirm the proper correction which is applied to the member(s) or section(s). In other embodiments, a computer learning algorithm, artificial intelligence, or the like may be able to determine the ideal correction based on the members, the section, the construction requirements, the manufacturing capabilities, the assembly process or the like.

In step 414, the assembly generation program 108 generates the section and member illustration and models. The illustrations and models are used for the manufacturing (where possible) of the members, and the assembly process of each section. As shown in the following figures, the members are “C” channels, which are formed in a cold roll-forming machine. This machine is able to receive the model or drawing files of the members and form each “C” channel member to the specifications created by the assembly generation program 108. In the following figures, various sizes, cuts, holes, notches, dimples, and other physical aspects of the members are able to be created through the cold roll forming machine based on the machine's specifications and abilities. The assembly generation program 108 is able to create illustrations or models in format or file types that are readable by the cold roll-forming machine.

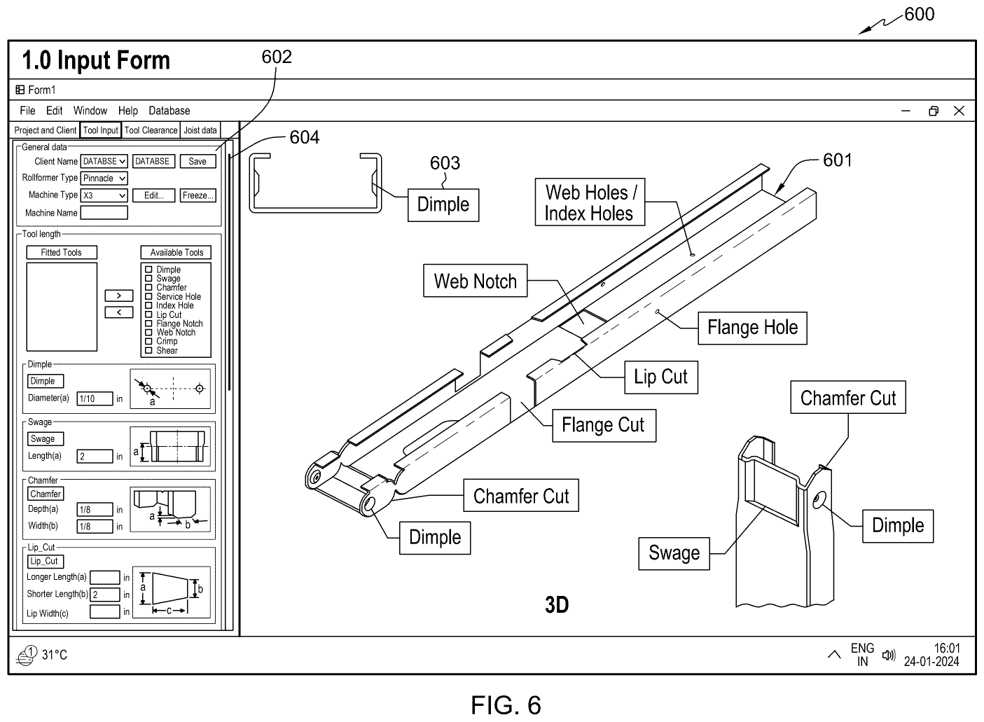

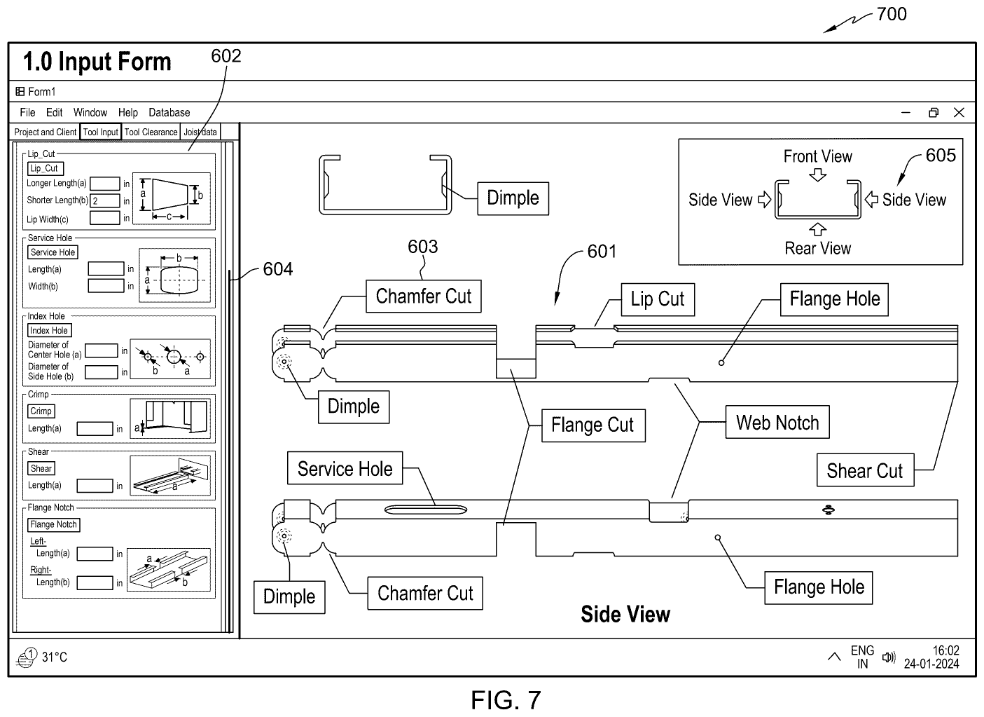

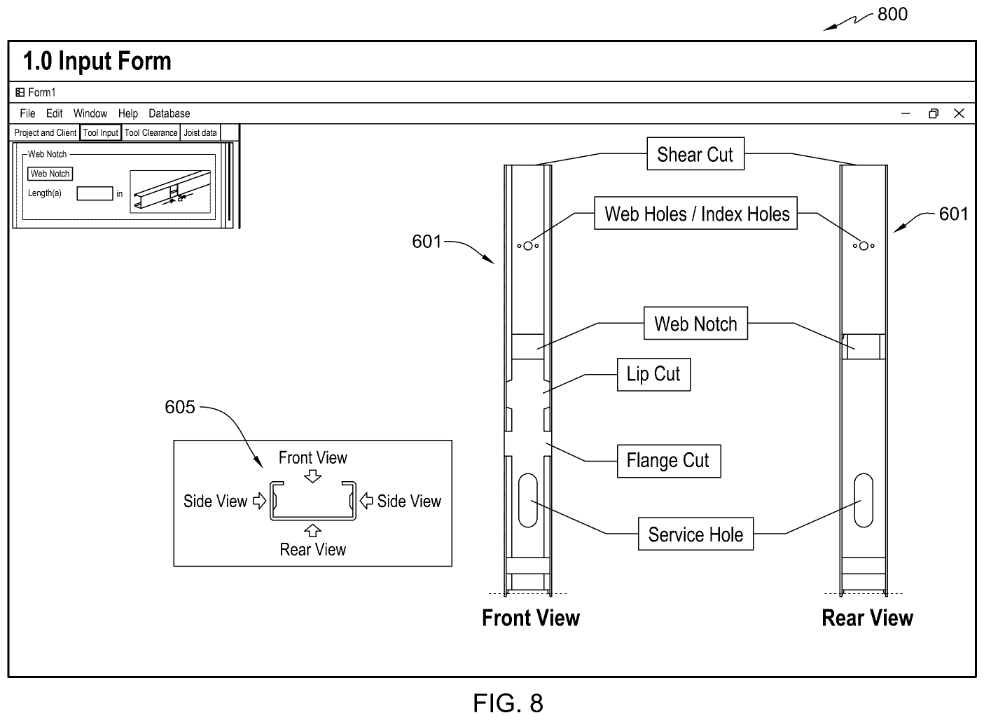

As shown in FIGS. 6-8 is member 601 shown in various positions and within various user interfaces, in accordance with one embodiment of the present invention. As shown in the Figures, user interface 600 shows member 601 in various illustrations. Descriptors 603 are shown to identify different features of the member (e.g. dimple, web/holes, web notch, flange hole, lip cut, flange cut, chamfer cut, dimple, chamfer cut, swage, and dimple). This list is for exemplary purposes as various other features of the members can exist, for example, fastener holes, fastening locations, crimping, or swage. User interfaces 600, 700, and 800 has user interface section 602, which allows for the description of the various features and allows for the modification of these features based on the user's preference. The user interface section 602 shows a select few of the features based on the viewing area of the user interface, but through navigating the section 602, other features are accessible through the scroll bar 604. In some embodiments, upon the section of the specific feature 603, the section 602 navigates to that specific feature 603 for the user to interact with. Modification of these features in section 602, applies these changes to the member which are visible in the model of member 601. If the modification of a feature affects other features, a warning or alert may be presented to inform the user that such a modification is not possible, or would not be possible based on known manufacturing machinery limitations. As shown in FIG. 7, the features of the service hole and the shear cut are shown, as these were not visible in FIG. 6, based on the orientation of member 601. As shown in FIGS. 7 and 8 is orientation window 605, which allows the user to interface with the orientation window 605 to rotate the member 601 and adjust the viewable side(s) of the member 601. The member 601 is able to be modified and manipulated by the user by using section 602 of the user interface to make amendments to the specific features listed. As the user adjusts these features, the member 601 is updated to show the amendments in the 3D model in real time. In some embodiments, section 602 is adjusted based on the member 601 selected and the known features of the member 601. In additional embodiments, the user is able to add features to the member 601 via section 602.

When each of the members are manufactured, these features are able to be incorporated into the member as it is being manufactured based on the manufacturing machinery 112 that is involved in the manufacturing process. In some embodiments, the rolling machine has the functions to incorporate these features. In some embodiments, an assembly type process is performed where multiple manufacturing machines 112 are needed to produce the member with all the required features The assembly generation program 108 is able to communicate with the manufacturing machinery 112 (e.g. cold form rolling machine and additional machines) that are used to incorporate the features into the members.

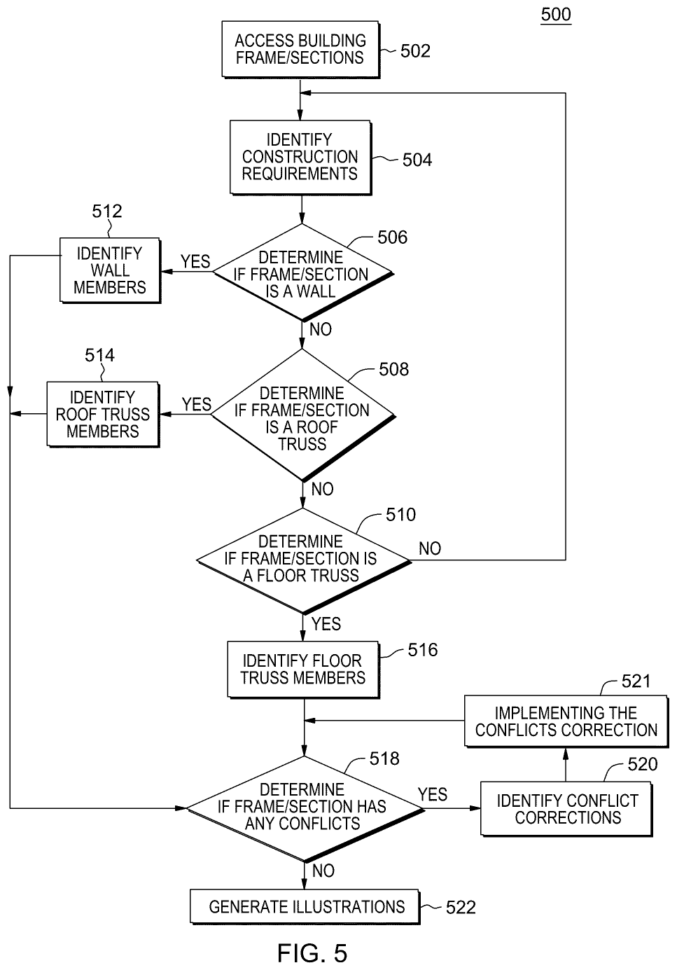

FIG. 5 depicts a flowchart 500 depicting a method according to another embodiment of the present invention. The method(s) and associated process(es) are now discussed, over the course of the following paragraphs, in accordance with one embodiment of the present invention. The program(s) described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In step 502, the assembly generation program 108 accesses the building model or the drawings. The building frame is identified, and the distinct sections are identified. Each section is comprised of members which are further identified. In some embodiments, the sections are created by the assembly generation program 108 based on the building model design and known section designs which can be extracted from the building model. The building or sections may be 3D models or 2D drawings. The model or drawings may have each member pre-identified. In other embodiments, the model or drawings do not identify each individual member identified or created, and the assembly generation program 108 is able to create estimates for the members.

In step 504, the assembly generation program 108 identifies the construction requirements for the building, the sections, and the members. The construction requirements assist the assembly generation program 108 in determining the physical properties of each of the members, sections, and the overall building frame to maintain proper building requirements, codes, and safety standards. The assembly generation program 108 establish types of materials which can be used for the members, types of fasteners or securing means that can be used, and the overall building design and requirements to adhere to necessary construction practices and safety requirements. This establishes requirements that all the following steps will have to adhere to when performing the following analysis.

The assembly generation program 108 performs an analysis first on each section to determine the section type. As depicted in FIG. 5, steps 506, 508, and 510 are associated with section types for walls, roof trusses, and floor trusses respectively. In other embodiments, where other section types are able to be identified or categorized, there are additional decision assembly generation program 108 would make to properly categorize each section by type. In additional embodiments with different section types, these may be replaced, or additional decisions may be incorporated into the process.

In some embodiments, the assembly generation program 108 identifies the construction requirements for each member. As shown in FIGS. 6-8, the member and all the features of the member or shown and assembly generation program 108 is able to determine the process to form or cut these members.

After the determination of the section type, the assembly generation program 108 identifies the members steps 512, 514, and 516 of each of the respective section types. Each section type has different properties and requirements based on the section type that affects the members. Assembly generation program 108 analyzes the members of the section differently based on the section type and the restrictions, limitations, or requirements each section type requires. This may be associated with the physical properties of the members, allowable fastening types, requirements feature, etc. of the members.

In decision 518 the assembly generation program 108 determines if there are section-to-section conflicts, or member-to-member conflicts. A conflict arises where when two or more members or sections (or both) are not properly positioned within the 3D model or 2D drawing resulting in an overlap of the sections or members and would not be able to be assembled properly because of the members or sections not fitting together correctly. If the assembly generation program 108 determines a conflict exists, the assembly generation program 108 identifies corrections to the conflict (step 520). If the assembly generation program 108 does not determine any conflicts are present, the assembly generation program 108 processes to generate the illustrations of the section and members (step 522).

In step 520, the assembly generation program 108 identifies at least one correction or solution to the conflicts based on an analysis of the members or sections involved in the conflict. These corrections or solutions are determined based on the construction requirements and may provide more than one correction type or solution. The corrections may include moving members, modifying members, or the replacement of members to adhere to the construction requirements. In some embodiments, a third party needs to confirm the proper correction that is applied to the member(s) or section(s). In other embodiments, a computer learning algorithm, artificial intelligence, or the like may be able to determine the ideal correction based on the members, the section, the construction requirements, the manufacturing capabilities, the assembly process or the like.

In step 521, the assembly generation program 108 implements a conflict correction to the specific member(s) or section(s) models. This conflict correction includes the modification of a member or section, the movement of the member or section, or the like. This correction is identified within the model so as to provide a notification to the modification, and the modification that was selected or chosen, and other modifications that could have been applied.

In step 522, the assembly generation program 108 generates the section and member illustration and models. The illustrations and models are used for the manufacturing (where possible) of the members, and the assembly process of each section. As shown in the following figures, the members are “C” channels, which are formed in the manufacturing machinery 112 (e.g. cold roll forming machine). This manufacturing machinery 112 is able to receive the model or drawing files of the members and form each “C” channel member to the specifications created by the assembly generation program 108. In the following figures, various sizes, cuts, holes, notches, dimples, and other physical aspects of the members are able to be created through the manufacturing machinery 112 based on the manufacturing machinery 112 specifications and abilities. The assembly generation program 108 is able to create illustrations or models in format or file types that are readable by the manufacturing machinery 112.

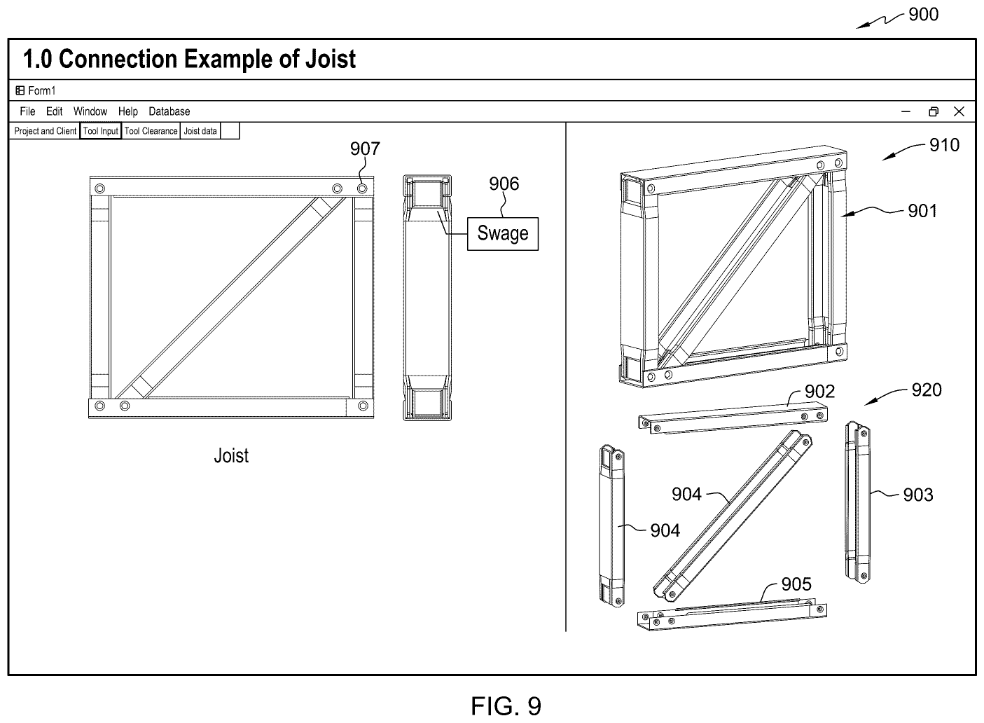

FIG. 9 depicts an illustration 900 of a user interface showing an exemplary section 901 in various orientations as well as in a disassembled view. View 910 shows an assembled view of the section. View 920 shows the disassembled view of the section where members 902, 903, 904, and 905 are visible. Additionally, what can also be shown is/are assembly steps that are necessary to form the section. The assembly generation program 108 is able to identify the interface regions of the members based on the assembly, the assembly process and the features of the members. In some embodiments, the assembly generation program 108 provides visual markings of the interface areas/regions/features and may also provide visual markings where conflicts are present on the drawings or in the 3D assemblies/models. Here swage 906 is shown which would be a step in the assembly process of the section. Once the members are assembled the process of swaging is performed at specific locations to form the section. Fastening locations 907 are also shown to indicate where once the members are in their final position, fasteners are used at these specific locations. The assembly process may occur manually or if the manufacturing machinery 112 is capable of assembling the section this can all be done in an automated fashion. Conflict resolutions may be presented in a drop down menu to provide the user the ability to determine different solutions to the conflicts based on which member or members is to be modified to overcome the conflict(s).

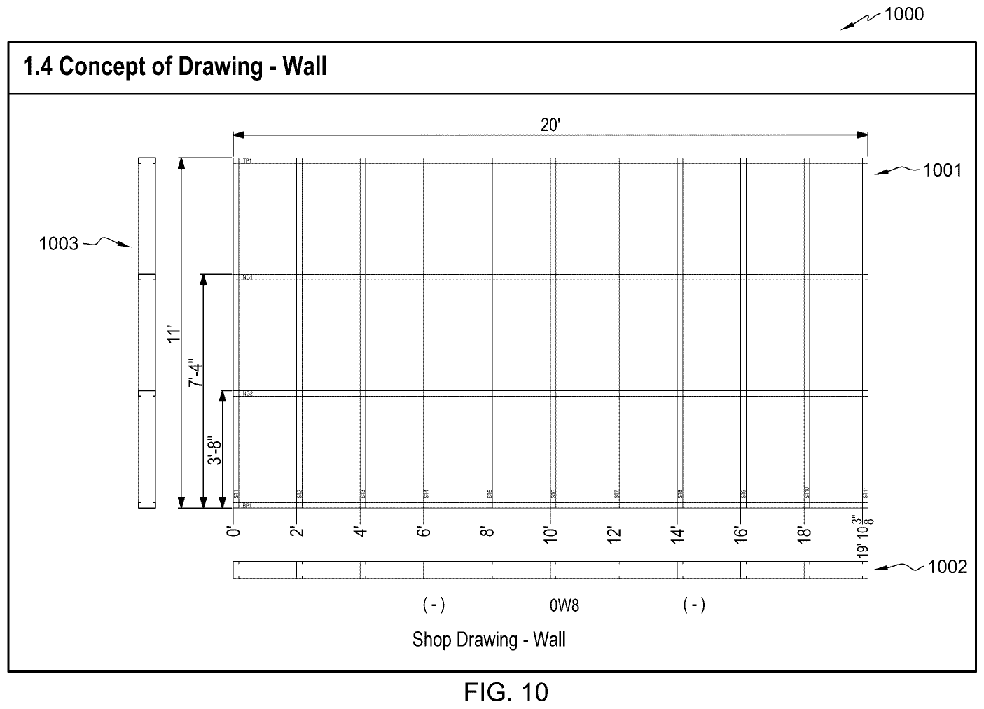

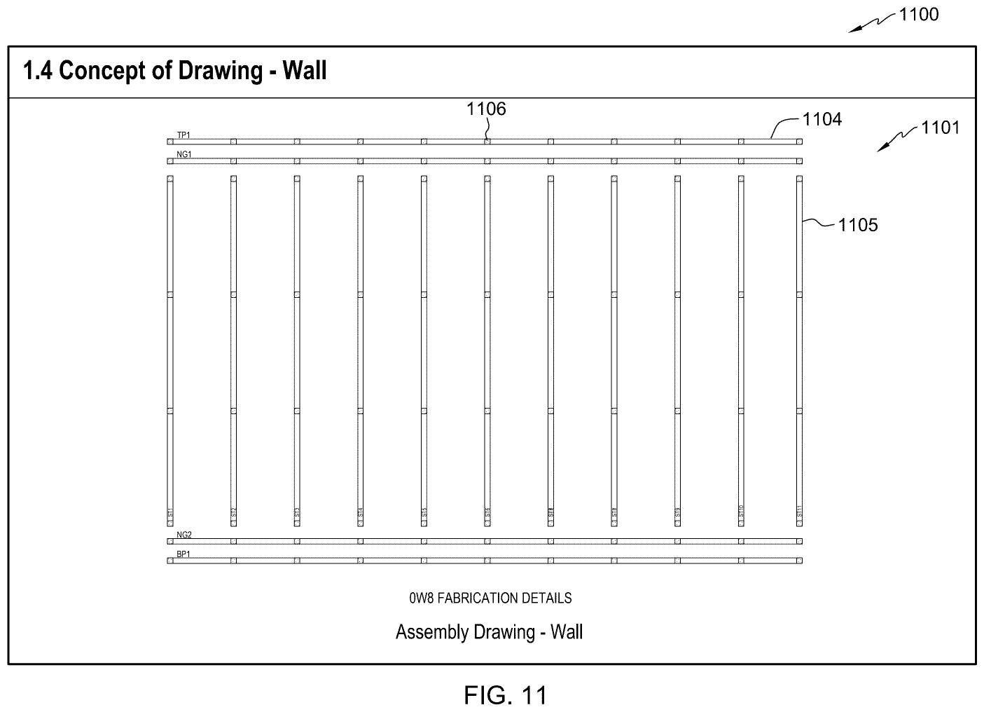

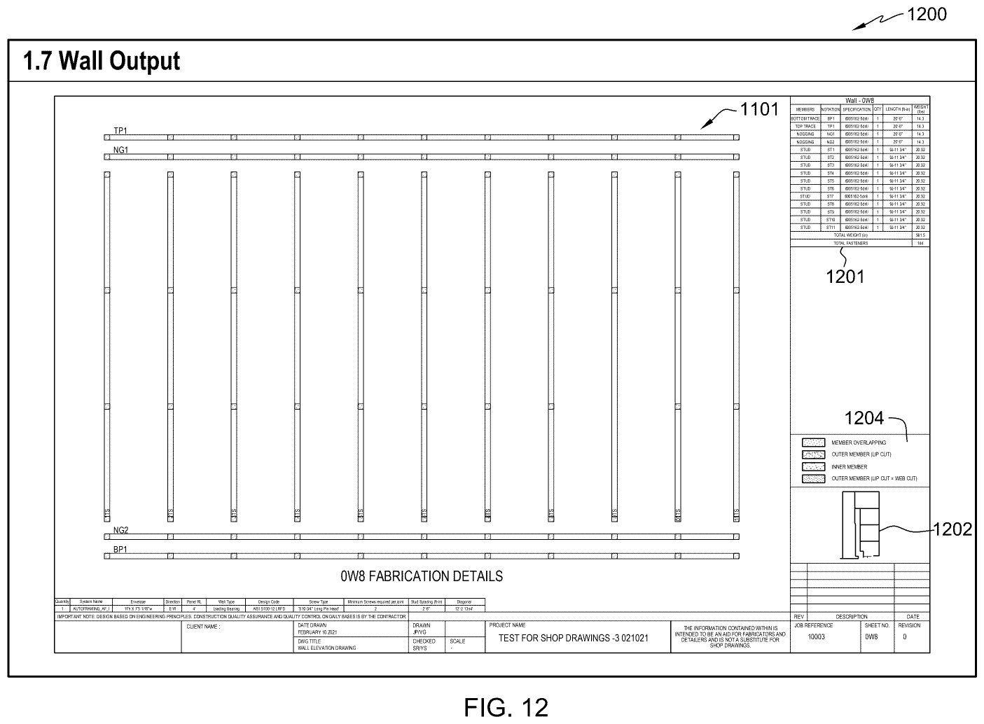

FIGS. 10-12 depict various illustrations of a wall panel in accordance with one embodiment of the present invention. These illustrations depict various outputs that the assembly generation program 108 is able to create that would be provided to the construction workers, the manufacturing machinery 112 or works, or other parties that are involved in the construction process of the building. This image depicts all of the members secured to one another in a final state. The dimensions are shown as visual indicators for the works to confirm that the assembled section matches the intended size. FIG. 10 depicts a shop drawing of a wall panel. The wall panel is shown in various orientations (1001, 1002, and 1003) to give the necessary views of the wall panel to provide the necessary dimensions. FIG. 11 depicts an assembly drawing of wall panel 1101 wherein the wall panel is disassembled. The wall panel is shown in a disassembled state with the vertical members 1004 and the horizontal members 1005 shown. Each member is identified with a member number to indicate its position within the wall panel. Areas of overlap of the members is shown (1006). The overlap may indicate that the member has a cutout or a hole. Each of these members would have an accompanying set of figures similar to FIGS. 6-8 to provide in detail all the features of each of these members. FIG. 12 depicts a shop drawing for the wall panel, wherein wall panel 1101 is shown in a disassembled view with each member being identified and listed in the bill of materials 1201. The key 1204 indicates the different visual portions of the member for areas of overlapping, inner members, and outer members. Additionally, the portion of the building where the wall panel is from is indicated in image 1202 of the building floor plan. The wall panel is identified (highlighted, bolded, colored, etc.) in this image 1202. Where this show drawing is accessed on a computing device, the bill of materials 1201, the wall panel 1101 members, and the image 1202 are able to be interacted with. For example, selecting a different wall panel in image 1202 would replace wall panel 1101 with the newly selected wall panel. Clicking on a member within the bill of materials 1201 would highlight the member within the wall panel 1101 assembly. Additionally, selecting a member of wall panel 1101 provides a detailed view (FIGS. 6-8) of the selected member.

The assembly drawings may, but are not limited to, include instructions for construction of the sections, lists of component parts, reference numbers, references to detail drawings or shop drawings, and other relevant information. The assembly drawings may also encompass dimensions, notation, and symbols. These assembly drawings are able to be formatted and adjusted to adhere to industry standards to ensure clarity and precise understanding.

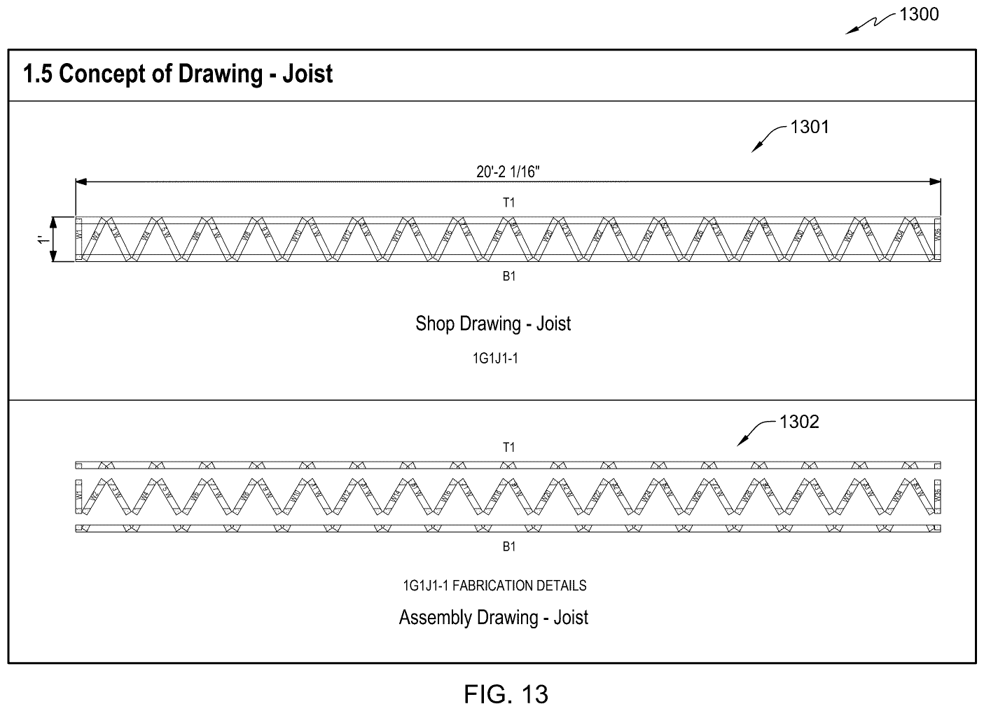

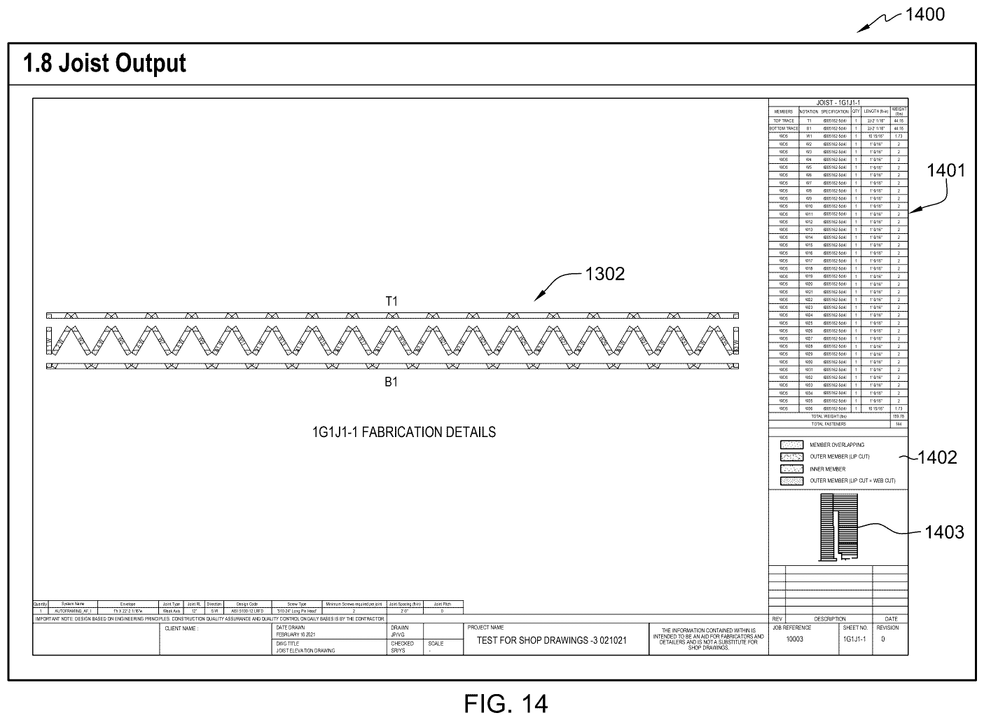

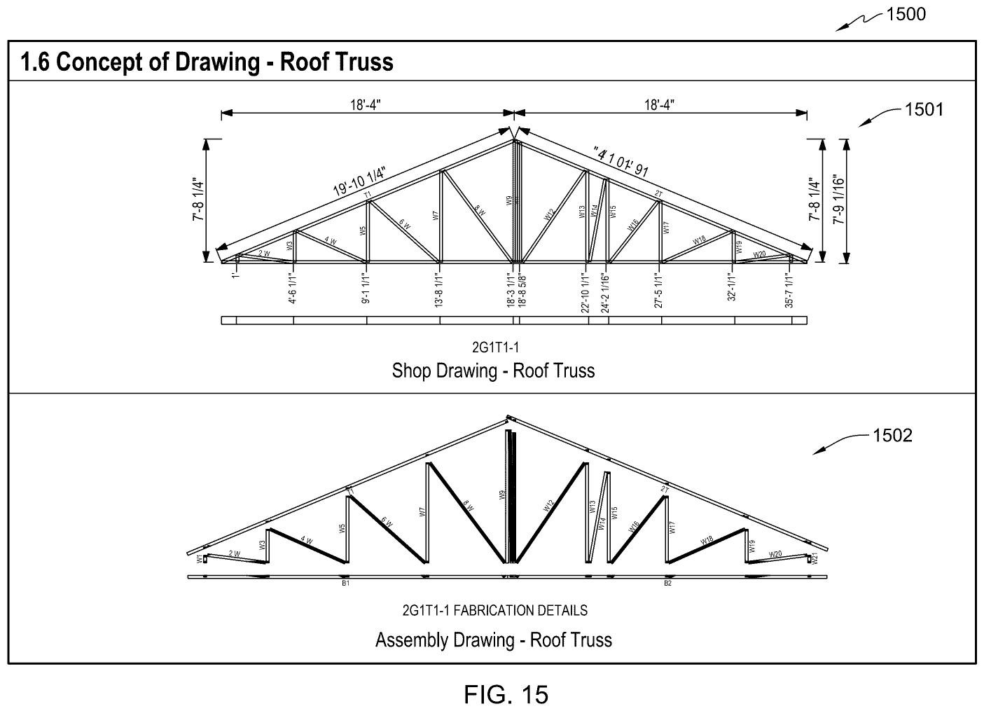

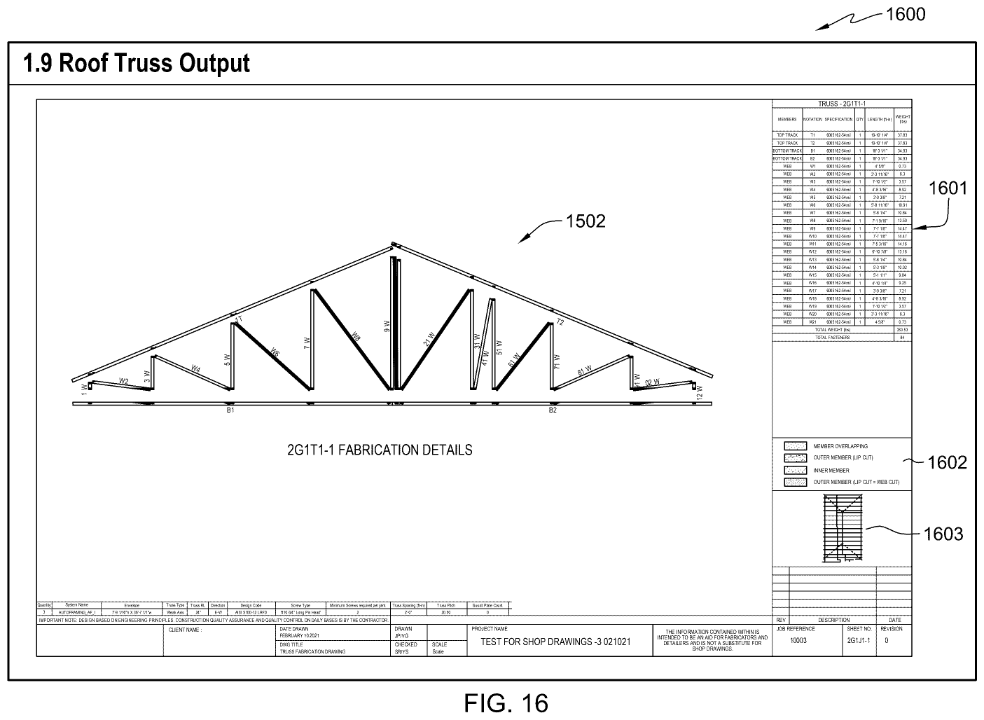

FIGS. 13-16 depict various illustrations of a floor truss and a roof truss in a similar fashion to the wall panel shown in FIGS. 10-12. These Figures are shown to provide additional examples of what the illustrations or user interface may depict based on the section type.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other devices to cause a series of operational steps to be performed on the computer, other programmable apparatus, or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Present invention: should not be taken as an absolute indication that the subject matter described by the term “present invention” is covered by either the claims as they are filed, or by the claims that may eventually be issued after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

The foregoing descriptions of various embodiments have been presented only for purposes of illustration and description. They are not intended to be exhaustive or to limit the present invention to the forms disclosed. Accordingly, many modifications and variations of the present invention are possible in light of the above teachings will be apparent to practitioners skilled in the art. Additionally, the above disclosure is not intended to limit the present invention.

In the specification and claims the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

Although various representative embodiments of this invention have been described above with a certain degree of particularity, those skilled in the art could make numerous alterations to the disclosed embodiments without departing from the spirit or scope of the inventive subject matter set forth in the specification and claims. Joinder references (e.g. attached, adhered, joined) are to be construed broadly and may include intermediate members between a connection of elements and relative movement between elements. As such, joinder references do not necessarily infer that two elements are directly connected and in fixed relation to each other. Moreover, network connection references are to be construed broadly and may include intermediate members or devices between network connections of elements. As such, network connection references do not necessarily infer that two elements are in direct communication with each other. In some instances, in methodologies directly or indirectly set forth herein, various steps and operations are described in one possible order of operation, but those skilled in the art will recognize that steps and operations may be rearranged, replaced, or eliminated without necessarily departing from the spirit and scope of the present invention. It is intended that all matter contained in the above description or shown in the accompanying drawings shall be interpreted as illustrative only and not limiting. Changes in detail or structure may be made without departing from the spirit of the invention as defined in the appended claims.

Although the present invention has been described with reference to the embodiments outlined above, various alternatives, modifications, variations, improvements and/or substantial equivalents, whether known or that are or may be presently foreseen, may become apparent to those having at least ordinary skill in the art. Listing the steps of a method in a certain order does not constitute any limitation on the order of the steps of the method. Accordingly, the embodiments of the invention set forth above are intended to be illustrative, not limiting. Persons skilled in the art will recognize that changes may be made in form and detail without departing from the spirit and scope of the invention. Therefore, the invention is intended to embrace all known or earlier developed alternatives, modifications, variations, improvements and/or substantial equivalent.

What is claimed is:

1. A method for generating an assembly illustration set for the construction of a building via a computing device, comprising:
accessing, by one or more processors, a model of a structure, wherein the model of the structure is comprised of a series of sections, and the series of structures are formed of members;
isolating, by one or more processors, a section from the structure;
detecting, by one or more processors, the section, wherein a section type is identified;
identifying, by one or more processors, each member of the section, and each feature of each member;
determining, by one or more processors, if conflicts are present between any members of the section, and wherein if a conflict between any members is determined identifying an amendment to at least one member and resolve the determined conflict;
applying, by one or more processors, the amendment to at least one member, and wherein the amendment resolves the conflict;
creating, by one or more processors, an assembly process of the section;
generating, by one or more processors, a set of illustrations depicting the section and the members; and
generating, by one or more processors, data for manufacturing machinery, wherein the data includes an assembly process of each member and of the section.

2. The method of claim 1, further comprising, detecting, by one or more processors, features of the assembly process.

3. The method of claim 1, wherein the set of illustrations are interactive.

4. The method of claim 1, further comprising, applying, by one or more processors, visual identifiers to the set of illustrations to indicate overlapping regions of the members.

5. The method of claim 1, further comprising, generating, by one or more processors, a 3D model of each member upon the resolution of the conflict.

6. The method of claim 1, further comprises, analyzing, by one or more processors, the features of the members based on the manufacturing machinery abilities to determine if the members are able to be manufactured.

7. The method of claim 1, wherein the features of the members are modifiable within a user interface.

8. The method of claim 1, wherein during the creation of the assembly process, further comprising, identifying, by one or more processors, that overlapping features of the members are aligned.

9. The method of claim 1, further comprising, applying, by one or more processors, a feature to a member, wherein a set of inputs are received related to the feature.

10. A computer program product for generating assembly plans, comprising,
the computer program product comprising a computer-readable storage medium having program instructions embodied therewith, the program instructions executable by a computing device to cause the computing device to:
program instructions to access a set of sections of a frame, wherein the sections are comprised of a set of members;
program instructions to analyze the set of sections, wherein it is determined the type of section each section represents;
program instructions to identify each member of the set of members that comprise each of the sections of the set of sections;
program instructions to analyze the members and determine if the members have a conflict within the section, wherein if it is determined that a conflict exists to identify the conflict; and
program instructions to generate a set of illustrations depicting the members of the section in an assembled and disassembled position.

11. The computer program product for generating assembly plans of claim 10, further comprising, detecting, features of the assembly process.

12. The computer program product for generating assembly plans of claim 10, further comprising, overlapping regions of each of the members.

13. The computer program product for generating assembly plans of claim 10, further comprising, applying modifications to features of the members, wherein the modifications are based on inputs received associated with the feature.

14. The computer program product for generating assembly plans of claim 10, further comprising, generating a 3D model of each member upon the resolution of the conflict.

15. The computer program product for generating assembly plans of claim 10, further comprises, analyzing the features of the members based on the manufacturing machinery abilities to determine if the members are able to be manufactured.

16. A system comprising:
a CPU, a computer readable memory, and a computer readable storage medium associated with a computing device;
program instructions to access a model, wherein the model is comprised of a set of sections and each section is comprised of a set of members;
program instructions to analyze the set of sections to determine the type of each section, wherein an assembly process is associated with each type of section;
program instructions to identify each individual member of the set of members that comprise each of the sections of the set of sections;
program instructions to analyze the set of members and the assembly process and determine if any members have a conflict;
program instructions to identify the members who are involved in the conflict based on the assembly process;
program instructions to modify the members involved in the conflict to overcome the conflict; and
program instructions to generate a set of illustrations depicting the set of members of each of the sections, wherein the set of illustrations identifies the assembly order and process, and wherein the set of illustrations are readable by a manufacturing machine.

17. The system comprising of claim 16, further comprising, program instructions to identify features of the members and determining which features are associated with the assembly process.

18. The system comprising of claim 16, further comprising, program instructions to modify a member based on a received input associated with a feature of the member.

19. The system comprising of claim 16, further comprising, program instructions to identify overlapping regions of the members and align these overlapping regions based on the assembly process.

20. The system comprising of claim 16, further comprising, program instructions to analyze the features of the members based on the manufacturing machinery abilities to determine if the members are able to be manufactured.
